(19) United States
(12) Patent Application Publication
(10) Pub. No.: US 2011/0188340 A1
(43) Pub. Date: Aug. 4, 2011

(54) Blender container and cover with tethered plug

(75) Inventors: David J. Kolar, Stow, OH (US); Robert M. Ulanski, Broadview Heights, OH (US)

(73) Assignee: Vita-Mix Corporation

(21) Appl. No.: 12/657,967

(22) Filed: Feb. 1, 2010

(51) Int. Cl. B01F 13/04; B01F 7/00

(52) U.S. Cl. 366/279; 366/349; 366/347

(57) ABSTRACT

The open top of a blender container (11) is closed by a cover (12). The cover (12) has an opening (25) therein so that items to be mixed in the blender container (11) by a rotatable blade (19) positioned therein can be introduced while the blade (19) is rotating. A plug (26) is carried by a strap (27) which is integrally formed with the cover so that the opening (25) can be readily closed by the plug (26). The opening (25) is sized so that human access to the blade (19) cannot be gained.

### TECHNICAL FIELD

This invention relates to a blender container and cover. More particularly, this invention relates to such a cover which has an opening which is closable by a plug which is tethered to the cover.

### BACKGROUND ART

Blender containers, which have a rotatable blade to mix food products placed therein, utilize covers to maintain the food products therein while they are being mixed. Typically such covers are provided with an opening so that food ingredients may be added during mixing if desired. However, such an opening must be small so that hands or fingers cannot be exposed to the rotating blade. In addition, when ingredients are not being added, the opening should preferably be closed so that the food being mixed does not escape. In the past, separate plugs have been provided to be inserted into an opening typically formed in the center of the cover. But such plugs tend to become lost, or at least temporarily misplaced, allowing the cover to be disadvantageously open during operation of the blender.

The need exists, therefore, for a blender container which has a cover with an opening therein which can be closed with a plug connected to the cover.

### DISCLOSURE OF THE INVENTION

It is thus an object of one aspect of the present invention to provide a cover for a blender container which includes a strap that carries a plug to close an opening in the cover.

It is an object of another aspect of the present invention to provide a cover for a blender, as above, in which the plug and strap are integrally formed with the cover.

These and other objects of the present invention, as well as the advantages thereof over existing prior art forms, which will become apparent from the description to follow, are accomplished by the improvements hereinafter described and claimed.

In general, an apparatus for closing the open top of a blender container made in accordance with the present invention includes a cover to close the open top with an opening being formed in the cover. A plug is integrally formed with the cover and is adapted to be received in the opening.

A cover for a blender container having an open top and made in accordance with the present invention includes a surface adapted to close the open top of the container. An opening is formed in the surface, and a plug is integrally formed with the surface and is adapted to be received in the opening.

In accordance with another aspect of the invention an apparatus for closing the open top of a container includes a cover to close the open top, the cover having an opening therein. A plug is sized to be received in the opening and a strap connects the plug to the cover.

The invention also contemplates the combination of a blender container and cover. The container has an open top and a rotatable blade therein. The cover closes the open top but has an opening therein so that an item can be placed in the container when the cover is on the container. A plug is integrally formed with the cover and is adapted to close the opening.

A preferred exemplary cover for a blender container is shown according to the concepts of the present invention is shown by way of example in the accompanying drawings without attempting to show all the various forms and modifications in which the invention might be embodied, the invention being measured by the appended claims and not by the details of the specification.

### BRIEF DESCRIPTION OF THE DRAWINGS

FIG. 1 is a fragmented view of a blender container and a cover made in accordance with the present invention.

FIG. 2 is a top perspective view of the cover of FIG. 1.

FIG. 3 is a bottom perspective view of the cover of FIG. 1.

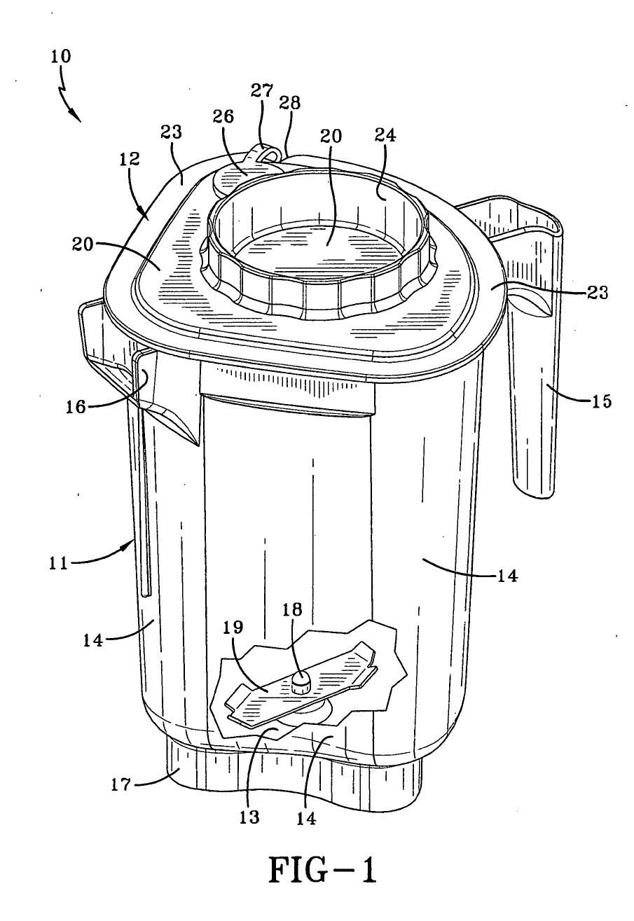

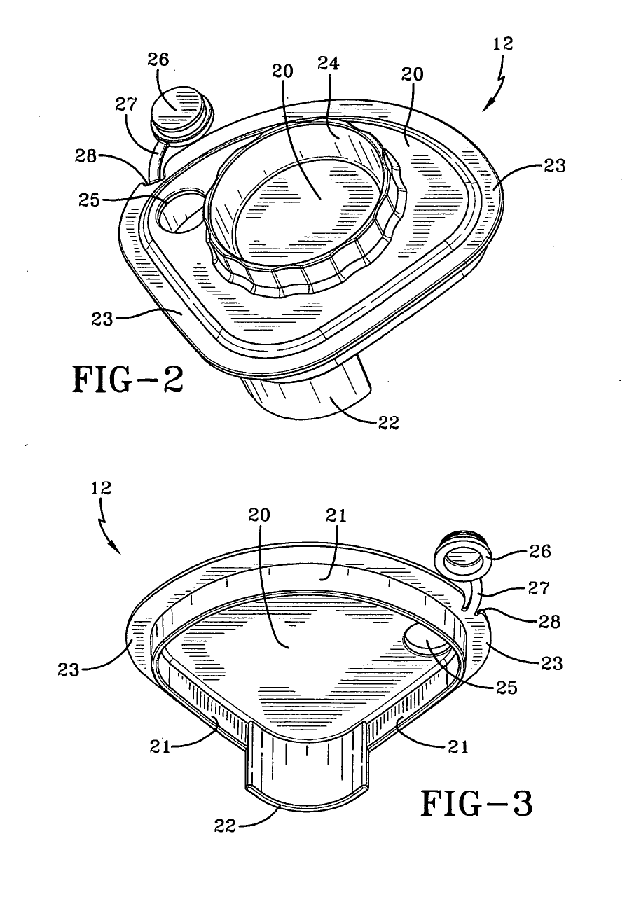

### PREFERRED EMBODIMENT FOR CARRYING OUT THE INVENTION

A blender container and cover assembly made in accordance with the present invention is generally indicated by the numeral 10. Assembly 10 includes a container, generally indicated by the numeral 11, and a cover generally indicated by the numeral 12.

Blender container 11 is typically made of a clear plastic material and includes a bottom surface 13 having sidewalls 14 extending upwardly from bottom surface 13 to form an open top adapted to be closed by cover 12. A handle 15 is typically formed on a sidewall 14, and a pouring spout 16 is formed on a sidewall near the top thereof and opposed to handle 15. A skirt 17 extends downwardly from bottom surface 13 and is adapted to be received around a pedestal of a conventional blender base (not shown). The blender base houses a motor which rotates a shaft 18 that carries a blender blade 19 which is spaced above bottom surface 13.

Cover 12 is typically molded of an elastomeric material and includes a top surface 20 which is adapted to close the open top of container 11. A flange 21 extends downwardly from top surface 20 and is sealingly received within the open top of container 11. A lip 22 can be provided such that when cover 12 is on container 11, lip 22 will close spout 16 to prevent the accidental discharge of material from container 11. Top surface 20 includes a peripheral rim 23 which extends outward of flange 21 and is adapted to rest on the top of container sidewalls 14 when cover 12 is on container 11. A generally circular grip member 24, which can have a fluted outer surface, may be provided extending upwardly from generally the center of the top surface 20 to assist the user in removing cover 12 from container 11.

In order to permit the user to add materials to the blender container 11 without removing cover 12, an opening 25 is formed in top cover surface 20. Opening 25 is typically small, on the order of no more than one inch in diameter, to comply with safety requirements to prevent a human hand or fingers access to reach blade 19 while it is operating. While opening 25 is shown as preferably being formed into surface 20 between grip member 24 and rim 23, it could be formed anywhere in top surface 20 including that portion within grip member 24. A plug 26, formed of a size to fit snugly in opening 25, is carried by a strap 27 which is connected to top surface rim 23. Strap 27 is prefereably integrally formed with rim 23 and plug 26 is preferably integrally formed with strap 27. Plug 26 is thus tethered to cover top surface 20 and cannot be misplaced when needed. A notch 28 may be formed in rim 23 to receive the tether strap 27 when plug 26 is positioned in opening 25. As such, strap 27 is recessed safely within the periphery of rim 23 when the plug 26 is in opening 25.

In view of the foregoing, it should be evident that a blender and cover assembly 10 as described herein accomplishes the objects of the invention otherwise substantially improves the art.

What is claimed is:

1. Apparatus for closing the open top of a blender container comprising a cover to close the open top, an opening in said cover, and a plug integrally formed with said cover and adapted to be received in said opening.

2. The apparatus of claim 1 further comprising a strap integrally formed with said cover and connecting said plug to said cover.

3. The apparatus of claim 2 further comprising a notch in said cover, said strap being received in said notch when said plug is in said opening.

4. The apparatus of claim 1 wherein said cover includes a top surface, said opening being in said top surface.

5. The apparatus of claim 4 further comprising a strap integrally formed with said top surface and connecting said plug to said cover.

6. The apparatus of claim 5 wherein said top surface includes a peripheral rim, said strap being connected to said rim.

7. The apparatus of claim 6 further comprising a notch formed in said rim, said strap being received in said notch when said plug is in said opening.

8. The apparatus of claim 6 further comprising a grip member extending upwardly from said top surface.

9. The apparatus of claim 8 wherein said opening is positioned between said grip member and said rim.

10. The apparatus of claim 1 wherein a rotatable blade is in the container and said opening is sized so as not to permit human access to the blade.

11. A cover for a blender container having an open top comprising a surface adapted to close the open top, an opening in said surface, and a plug integrally formed with said surface and adapted to be received in said opening.

12. The cover of claim 11 further comprising a strap integrally formed with said surface and connected to said plug.

13. The cover of claim 12 wherein said surface includes a peripheral rim, said strap being connected to said rim.

14. The cover of claim 13 further comprising a notch formed in said rim, said strap being received in said notch when said plug is in said opening.

15. The cover of claim 13 further comprising a grip member extending upwardly from said surface.

16. The cover of claim 15 wherein said opening is positioned between said grip member and said rim.

17. The cover of claim 11 wherein a rotatable blade is in the container and said opening is sized so as not to permit human access to the blade.

18. Apparatus for closing the open top of a container comprising a cover to close the open top, an opening in said cover, a plug sized to be received in said opening, and a strap connecting said plug to said cover.

19. The apparatus of claim 18 cherein said strap is integrally formed with said cover and said plug is integrally formed with said plug.

20. In combination, a blender container having an open top and a rotatable blade therein, and a cover on said container to close said open top, said cover having an opening therein so that an item can be placed in said container when said cover is on said container, and a plug integrally formed with said cover and adapted to close said opening.

21. The combination of claim 20 wherein said container has a rotatable blade therein, said opening being sized so as not to permit human access to said blade.

22. The combination of claim 20 further comprising a strap integrally formed with said cover and connecting said plug to said cover.

23. The combination of claim 22 further comprising a notch in said cover, said strap being received in said notch when said plug is in said opening.
